(19) United States
(12) Patent Application Publication
(10) Pub. No.: US 2013/0100677 A1
(43) Pub. Date: Apr. 25, 2013

(54) LIGHTING STRUCTURE

(71) Applicant: Raytheon Company, Waltham, MA (US)

(72) Inventor: Gregory A. Powell, Clearwater, FL (US)

(73) Assignee: RAYTHEON COMPANY, Waltham, MA (US)

(21) Appl. No.: 13/652,586

(22) Filed: Oct. 16, 2012

Related U.S. Application Data
(60) Provisional application No. 61/549,708, filed on Oct. 20, 2011.

(51) Int. Cl. F21V 13/04; F21V 7/00

(52) U.S. Cl. 362/296.01

(57) ABSTRACT

An improved light fixture is disclosed. One embodiment comprises a light source, a first optical element that focuses light provided by a light source in the forward direction, a second optical element that reflects light in the reverse direction, and a third optical element that focuses light in the forward direction.

### RELATED APPLICATIONS

This application claims priority under 35 U.S.C. §119(e) to U.S. Provisional Application Ser. No. 61/549,708, entitled “LIGHTING STRUCTURE,” filed on Oct. 20, 2011, which is herein incorporated by reference in its entirety.

### BACKGROUND

Performance of Light Emitting Diodes (LEDs) has increased significantly. LEDs with power efficiency exceeding incandescent lamps have been developed and are available in the marketplace. LEDs may be used in both low power areas such as indicator lights for electronic devices and also in high power applications such as overhead lighting. Although LEDs have many advantages, there are challenges. One consideration is illumination angle of LED devices. Light generated by LEDs may not be emitted at a desired angle.

### SUMMARY OF INVENTION

Aspects and embodiments are directed to a lighting structure that provides forward and reverse directed lighting.

According to one embodiment, a lighting structure comprises a light source, a first optical element, a second optical element, and a third optical element. The first optical element focuses light provided by the light source in the forward direction. The second optical element reflects light provided by the light source and the first optical element in the reverse direction. The third optical element further focuses light provided by the light source and the first optical element in the forward direction.

According to aspects and embodiments, the light source is an LED.

According to aspects and embodiments, the second optical element is ring shaped and has a reflective surface that is angled to reflect light at an angle. According to aspects and embodiments, the second optical element is metal.

According to aspects and embodiments, the first optical element is a prismatic lens. According to aspects and embodiments, the first optical element is conical shaped.

According to aspects and embodiments, the third optical element is a prismatic lens. According to aspects and embodiments, the third optical element is circular shaped and substantially flat.

According to aspects and embodiments, the light source, the first optical element, the second optical element, and the third optical element together are operable to output light in the forward direction in a substantially circular shape when the light is viewed in cross section. According to aspects and embodiments, the light source, the first optical element and the second optical element are operable to output light in the reverse direction in a substantially circular shape when the light is viewed in cross section

According to aspects and embodiments, the light source, the first optical element, the second optical element, and the third optical element together form an overhead light.

According to another embodiment, a lighting structure comprises a light source, a first optical element, a second optical element, and a third optical element. The first optical element comprises a first lens having a narrower end and a wider end, the narrower end of the lens being coupled to and configured to receive light from the light source. The second optical element comprises a ring shape having a reflective surface and an opening, the second optical element being configured to be attached to the wider end of the first optical element. The third optical element comprises a second lens configured to attach to the second optical element within the opening of the second optical element.

According to aspects and embodiments, the light source is an LED.

According to aspects and embodiments, the reflective surface of ring shaped second optical element is angled to reflect light at an angle. According to aspects and embodiments, the second optical element is metal

According to aspects and embodiments, the first lens is a prismatic lens. According to aspects and embodiments, the first lens is conical shaped.

According to aspects and embodiments, the second lens is a prismatic lens. According to aspects and embodiments, the second lens is circular shaped and substantially flat.

According to aspects and embodiments, the light source, the first lens, the ring shaped reflective surface, and the second lens together are operable to output light in the forward direction in a substantially circular shape when the light is viewed in cross section. According to aspects and embodiments, the light source, the first lens, and the ring shaped reflective surface together are operable to output light in the reverse direction in a substantially circular shape when the light is viewed in cross section.

According to aspects and embodiments, the light source, the first lens, the ring shaped reflective surface, and the second lens together form an overhead light.

Still other aspects, embodiments, and advantages of these exemplary aspects and embodiments, are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. Where technical features in the figures, detailed description or any claim are followed by references signs, the reference signs have been included for the sole purpose of increasing the intelligibility of the figures and description. In the figures, each identical or nearly identical component that is illustrated in various figures is represented by a like numeral. For purposes of clarity, not every component may be labeled in every figure. In the figures:

FIG. 1 is a perspective view of a lighting structure;

FIG. 2 is a perspective view of a lighting structure according to one embodiment;

FIG. 3 is an exploded view of a second and a third optical element of the lighting structure; and

FIG. 4 illustrates one use of the lighting structure.

### DETAILED DESCRIPTION

Lighting structures with LEDs are being adopted for overheading lighting, such as in high ceiling environments, industrial lighting, warehouses, and the like. These fixtures have a reflector that is used to focus light emitted from an LED source in a desired direction or angle toward the floor. Such additional reflectors are used optimize the light extraction to a desired viewing angle toward the floor and to produce a conical type beam. However, such structures don't provide for reflecting the light produced by the LED back toward the ceiling to also provide upward lighting. One of the advantages of the embodiments of the disclosure is to provide a structure that provides both a focused light beam, i.e. toward the floor, and also a reflected light beam, i.e. toward the ceiling.

It is to be appreciated that embodiments of the methods and apparatuses discussed herein are not limited in application to the details of construction and the arrangement of components set forth in the following description or illustrated in the accompanying drawings. The methods and apparatuses are capable of implementation in other embodiments and of being practiced or of being carried out in various ways. Examples of specific implementations are provided herein for illustrative purposes only and are not intended to be limiting. In particular, acts, elements and features discussed in connection with any one or more embodiments are not intended to be excluded from a similar role in any other embodiment.

Also, the phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. Any references to front and back, left and right, top and bottom, upper and lower, and vertical and horizontal are intended for convenience of description, not to limit the present systems and methods or their components to any one positional or spatial orientation.

Where the term “reflector” is used, it is intended to any material that can be formed in the noted structure and the will reflect light. Where the term “lens” is used, it is intended to cover any lens that can be used in the noted structure and that reflects and focus light.

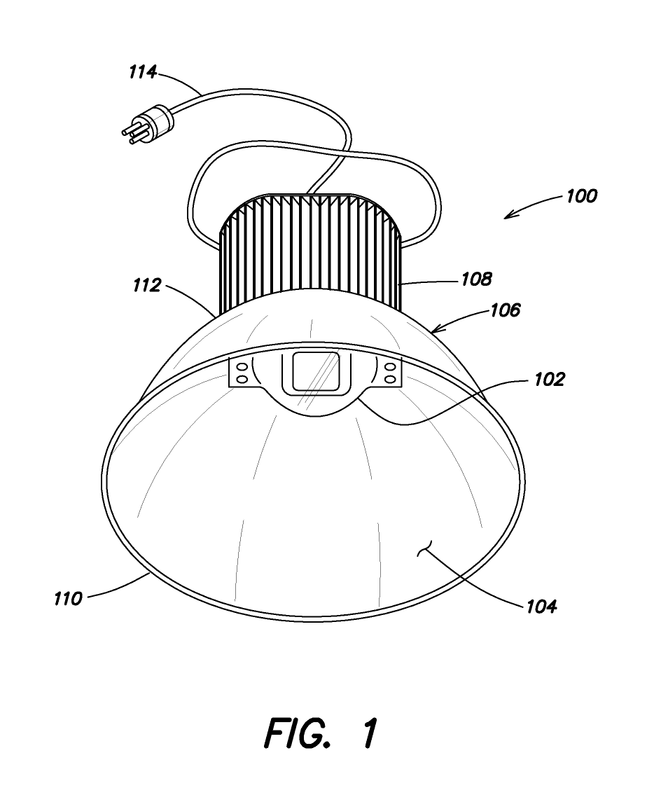

With reference to FIG. 1, an embodiment of a lighting structure 100 comprises a light source 102 and an optical focusing element 106. In one embodiment, the light source is an LED light source that is provided with solid lens and an open backing as pictured in FIG. 1. However, it is to be appreciated that the LED light source may have other structure, such as for example, an LED chip mounted to a substrate that is highly reflective and forms one reflective surface of the lighting structure. An inner wall 104 of the optical element 106 provides a highly reflective surface. The LED light source is operable to produce a light output. The combination of the LED light source 102 and the inner wall of the 104 of the optical element 106 are configured to direct light output in a targeted direction, such as toward a floor when the lighting structure 100 is hung from a ceiling. For the purpose of this application, the targeted direction is defined as “forward direction”. It is to be appreciated that the lighting structure may also comprise a heat dissipating element, such as a heat sink 108, to dissipate heat from the LED light source. The lighting structure also comprise a line cord 114 for powering the lighting structure 100, and appropriate electronics (not illustrated) to convert the line voltage to an operating level suitable for the LED light source 102.

The optical element 106 can be a cylindrical structure with inner conical shape as illustrated in FIG. 1. The inner conical shape wall 104 may have a wider end 110 and a narrower end 112. The inner conical shape wall 104 can be coated with highly reflective material to increase reflectivity and defines a reflective surface. The highly reflective material can be a metal such as aluminum and silver, or a non metallic type of material such as PPA. The wider end 110 of the conical shape wall is facing in the forward direction. The LED light source 102 is coupled the narrower end 112 of the conical shaped element 106.

The structure illustrated in FIG. 1 directs light in the forward direction from the LED light source 102 toward the wider end of the conical shaped optical element 106, so as to provide a spot type illumination beam, such as on a floor when the lighting structure is suspended from a ceiling. According to aspects and embodiments of the disclosure, it is also desirable to provide light in an opposite direction from the forward direction, defined herein as “reverse direction”, for example so as to illuminate a ceiling when the lighting structure is hung from the ceiling.

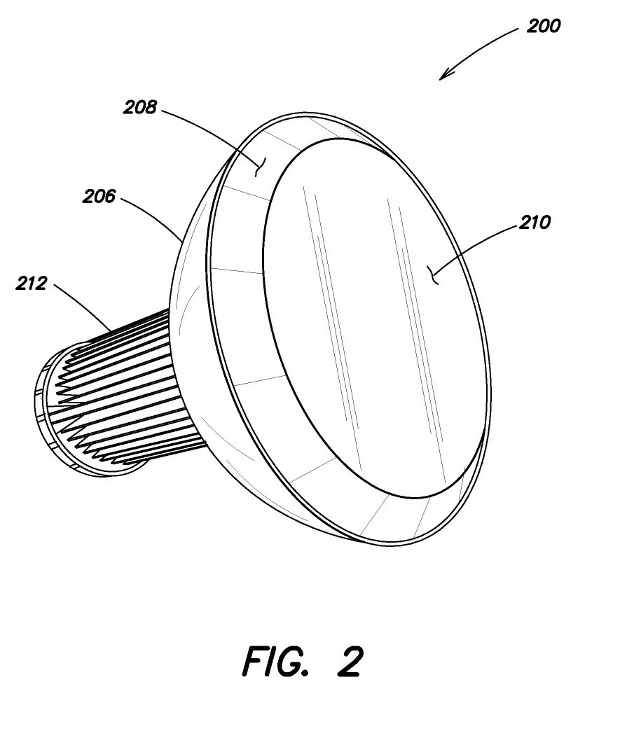

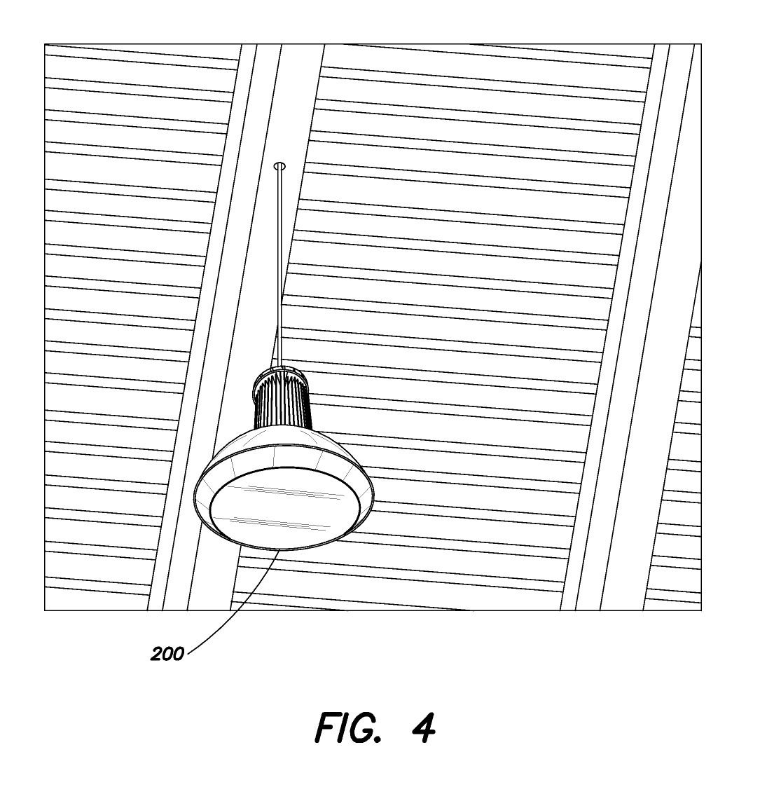

With reference to FIG. 2, there is illustrated an embodiment of a lighting structure 200 which includes a light source (not illustrated). The light source can be similar to or the same as the LED light source 102 of the embodiment of FIG. 1. The LED light source is operable to produce a light output. This embodiment also comprises and a first optical focusing element 206, a second optical reflecting element 208, and a third optical focusing element 210. According to this embodiment, a combination of the light source, the first optical element 206, the second optical element 208, and the third optical element 210 are configured to both direct light output in the forward direction, such as toward a floor when the lighting structure 200 is hung from a ceiling (as illustrated in FIG. 4), as well as in the reverse direction, such as toward the ceiling when the lighting structure 200 is hung from a ceiling (as illustrated in FIG. 4). It is to be appreciated that this embodiment may also comprise a heat dissipating element, such as a heat sink 212, to dissipate heat from the light source, as well as a line cord for powering the lighting structure, and appropriate electronics (not illustrated) to convert the line voltage to an operating level suitable for the light source.

According to aspects of this embodiment, the first optical element comprises a first prismatic lens having a conical shape with a narrower end and a wider end, wherein the narrower end of the conical shaped lens is configured to be connected to the light source is and is also configured to be operatively coupled to receive light from the LED light source. The prismatic lens receives the light from the LED light source and focuses the light in the forward direction.

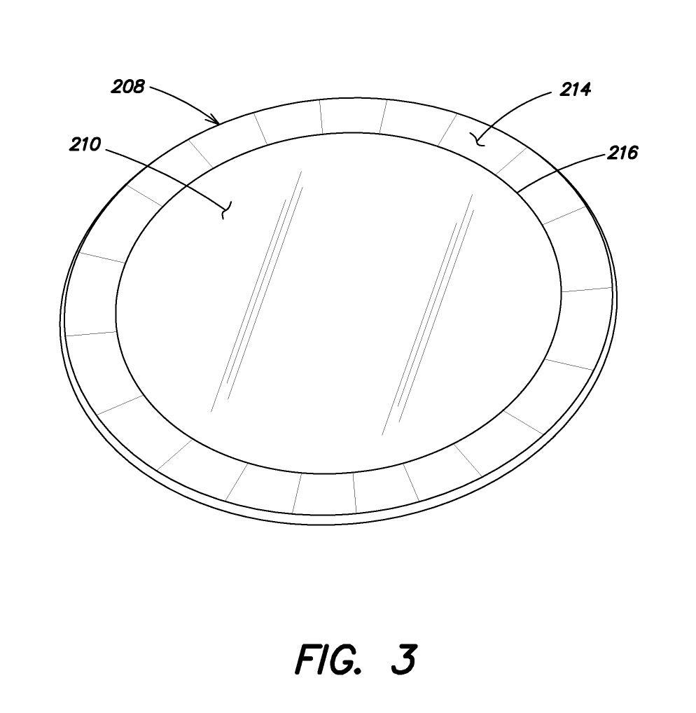

With reference to FIG. 3, according to aspects of this embodiment the second optical element 208 is ring shaped and includes a reflective surface 214 and an opening 216. The second optical element is configured to be attached to the wider end of the first optical element, as illustrated, for example, in FIG. 2. According to aspects of this embodiment, the reflective surface of the ring shaped optical element 214 is configured to reflect light focused by the combination of the LED light source and the prismatic lens 206 from the forward direction toward the backward direction. Typically, the second optical element can be implemented using a ring shape silver plate. Other reflective metallic material can also be used. According to aspects of this embodiment, the reflective surface 214 of the ring shaped second optical element is angled to reflect the light at an angle in the reverse direction back toward the conical shaped prismatic lens. It is to be appreciated that the angle of the reflective surface of second optical element can be varied so as to vary the cross section of light provided in the reverse direction, and thus the intensity of the light provided. Such modifications are contemplated by this disclosure. It is to be appreciated that the combination of the ring shaped second optical element and the conical shaped prismatic lens combine to direct the light in the reverse direction to provide a focused light in the reverse direction, for example so as to illuminate the ceiling in a circular cross-section with the lighting structure suspended from the ceiling.

With reference to FIG. 3, according to aspects of this embodiment, the third optical element 210 comprises a substantially flat prismatic lens that is configured in combination with the ring shaped second optical element to fit within the opening of the second optical element. According to aspects of this embodiment, the third optical element 210 is configured to focus light provided by the combination of the light source and the prismatic lens 206 in the forward direction, for example, so as to illuminate the floor in a circular cross-section with the lighting structure suspended from the ceiling.

It is to be appreciated that the first, second and third optical elements described herein can be separate elements, or they can be integral elements. It is to be appreciated that where the optical elements are separate optical elements they can be attached, for example, by using conventional methods such as glue. For embodiments where the elements are integrally formed, for example, the ring shaped reflective second optical element can be formed as part of the conical shaped first optical element, and the circular shaped lens third optical element can also be formed as part of the conical shaped first optical element. Alternative lighting embodiments can incorporate additional optical elements. Various combinations are contemplated by the disclosure.

Some advantages of this embodiment are that the lighting structure provides both reverse direction lighting as well as forward direction lighting. In addition, this embodiment can also reduce glare provided by the lighting structure as illustrated in FIG. 1. In addition, this embodiment can also provide an increased illumination level (candle level) in the forward direction, such as on a floor when suspended from a ceiling.

Having described above several aspects of at least one embodiment, it is to be appreciated various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only.

1. A lighting structure comprising:
a light source that provides light;
a first optical element, that focuses light provided by the light source in a forward direction;
a second optical element, and a third optical element that reflects light provided by the light source and the first optical element in a reverse direction; and
a third optical element that further focuses light provided by the light source and the first optical element in the forward direction.

2. The lighting apparatus of claim 1, wherein the light source is an LED.

3. The lighting apparatus of claim 1, wherein the second optical element is ring shaped and has a reflective surface that is angled to reflect light at an angle.

4. The lighting apparatus of claim 1, wherein the first optical element is a prismatic lens.

5. The lighting apparatus of claims 1, wherein the third optical element is a second prismatic lens.

6. The lighting apparatus of claim 1, wherein the third optical element is circular shaped and substantially flat.

7. The lighting apparatus of claim 1, wherein the second optical element is metal.

8. The lighting apparatus of claim 1, wherein the first optical element is conical shaped.

9. The lighting apparatus of claim 1, wherein the light source, the first optical element, the second optical element, and the third optical element together are operable to output light in the forward direction in a substantially circular shape when the light is viewed in cross section.

10. The lighting apparatus of claim 1, wherein the light source, the first optical element and the second optical element are operable to output light in the reverse direction in a substantially circular shape when the light is viewed in cross section

11. The lighting apparatus of claim 1, wherein the light source, the first optical element, the second optical element, and the third optical element together form an overhead light.

12. A lighting structure comprising:
a light source that provides light;
a first optical element comprising a first lens having a narrower end and a wider end, the narrower end of the lens being coupled to and configured to receive light from the light source;
a second optical element comprising a ring shape having a reflective surface and an opening, the second optical element configured to be attached to the wider end of the first optical element,
and a third optical element comprising a second lens configured to attach to the second optical element within the opening of the second optical element.

13. The lighting apparatus of claim 12, wherein the light source is an LED.

14. The lighting apparatus of claim 12, wherein the reflective surface of ring shaped second optical element is angled to reflect light at an angle.

15. The lighting apparatus of claim 12, wherein the first lens is a prismatic lens.

16. The lighting apparatus of claims 12, wherein the second lens is a prismatic lens.

17. The lighting apparatus of claim 12, wherein the second lens is circular shaped and substantially flat.

18. The lighting apparatus of claim 12, wherein the second optical element is metal.

19. The lighting apparatus of claim 12, wherein the first optical element is conical shaped.

20. The lighting apparatus of claim 12, wherein the light source, the first lens, the ring shaped reflective surface, and the second lens together are operable to output light in the forward direction in a substantially circular shape when the light is viewed in cross section.

21. The lighting apparatus of claim 12, wherein the light source, the first lens, and the ring shaped reflective surface together are operable to output light in the reverse direction in a substantially circular shape when the light is viewed in cross section

22. The lighting apparatus of claim 12, wherein the light source, the first lens, the ring shaped reflective surface, and the second lens together form an overhead light.
